(19) United States
(12) Patent Application Publication
(10) Pub. No.: US 2008/0076475 A1
(43) Pub. Date: Mar. 27, 2008

(54) MEMORY CARD AND SYSTEM INCLUDING THE SAME

(75) Inventor: Yong-Wook KIM, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 11/828,410

(22) Filed: Jul. 26, 2007

(30) Foreign Application Priority Data
Sep. 21, 2006 (KR) 2006-91892

(51) Int. Cl. H04M 1/00

(52) U.S. Cl. 455/558

(57) ABSTRACT

A system includes a subscriber identity module (SIM card and a communication circuit. The communication circuit communicates with an external device through a first wireless interface, and communicates with the SIM card through a second wireless interface. The SIM card includes a functional circuit core, an antenna and a transceiver connected to the functional circuit core and the antenna. The transceiver is configured to communicate a data signal between the functional circuit core and the communication circuit through the antenna, the communication circuit using the second wireless interface.

### CROSS-REFERENCE TO RELATED APPLICATIONS

A claim of priority is made to Korean Patent Application No. 10-2006-0091892, filed on Sep. 21, 2006, the subject matter of which is hereby incorporated by reference.

### BACKGROUND OF THE INVENTION

1. Field of the Invention

The present invention relates to an integrated circuit (IC) card, and more particularly, to a subscriber identity module (SIM) card and a system including the SIM card.

2. Description of the Related Art

A SIM card is a contact IC card using 8 pins (e.g., C1 to C8 in FIG. 2). The SIM card uses the 8 pins to support the International Organization for Standardization (ISO) 7816 interface, related to contact IC cards.

The SIM card stores various types of user information, such as a serial number of a communication terminal, a bank account number, a registered phone number, or a text message of a user. Examples of SIM card implementations include a SIM card mounted to a global system for mobile communications (GSM) terminal, a universal subscriber identity module (USIM card mounted to code division multiple access (CDMA) terminals, and a roaming subscriber identity module (R-SIM) card mounted to both GSM and CDMA terminals.

Because the number of pins of the SIM card is limited, interface protocols that can be used with the SIM card are also limited. For example, five pins of the SIM card are used for the ISO 7816 interface protocol, which is the basic interface protocol of the SIM card. When the SIM card is used in a high-end product, the remaining three pins of the SIM card may be used, for example, for a universal serial bus (USB) interface protocol or a multi-media card (MMC) interface protocol. The USB interface protocol, developed by Intel, Compaq, IBM, Digital Equipment Corporation (DEC), Microsoft, NEC and Northern Telecom, enables peripheral devices to interface with host computers, for example. The MMC interface protocol relates to MMC flash memory cards, which are primarily used in portable digital devices.

The SIM card uses all eight pins for an ISO 7816 interface in conjunction with a USB interface or an MMC interface. In the SIM card market, SIM cards supporting contactless wireless communication, such as the ISO 14443 interface protocol, are required to provide additional services. Such SIM cards may be used in products that receive and transmit large amounts of data, and that require high speed processing. These additional services may include, for example, transportation cards, financial payments, electronic money transactions and office access management. However, the SIM card cannot provide various interfaces, due to the limitations in the number of pins in the SIM card and its size.

### SUMMARY OF THE INVENTION

An aspect of the present invention provides a system including a subscriber identity module (SIM) card and a communication circuit. The communication circuit communicates with an external device through a first wireless interface, and communicates with the SIM card through a second wireless interface. The SIM card may include a functional circuit core, an antenna and a transceiver connected to the functional circuit core and the antenna. The transceiver may be configured to transmit and/or receive a data signal between the functional circuit core and the communication circuit through the antenna, where the communication circuit uses the second wireless interface.

The first wireless interface may be a near field communication interface. Also, the first wireless interface and the second wireless may interface use different frequency bands for communication. The transceiver may transmit the data signal to the communication circuit through the second wireless interface, where the data signal includes a preamble added to data output from the functional circuit core. Also, the communication circuit may transmit the data signal to the transceiver through the second wireless interface, where the data signal includes a preamble added to data to be input to the functional circuit core.

Another aspect of the present invention provides a SIM card including a SIM core, an antenna and a transceiver connected to the SIM core and the antenna. The transceiver converts data from the SIM core into an RF data signal, and transmits the RF data signal through the antenna to a communication circuit, which transmits the RE data signal to an external device. The transceiver may also receive an RF data signal from the external device through the communication circuit and the antenna, and sends at least a portion of the RF data signal to the SIM core.

Yet another aspect of the present invention provides a SIM card, which includes a SIM core, an antenna and a transceiver connected to the SIM core and the antenna. The transceiver receives an RF data signal from an external device through the antenna, via a communications circuit, and sends at least a portion of the RF data signal to the SIM core. The transceiver may convert data to be transmitted from the SIM core to the external device into an RF data signal and transmit the RF data signal through the antenna to the communications circuit, which transmits the RF data signal to the external device.

The RF data signal may include a preamble. The transceiver may add the preamble to data provided from the SIM core. Also, when the RF data signal received through the antenna includes a preamble, the transceiver may send at least a portion of the RF data signal to the SIM core.

### BRIEF DESCRIPTION OF THE DRAWINGS

The accompanying figures are included to provide a further understanding of the present invention, and are incorporated in and constitute part of this specification. The embodiments of the present invention will be described with reference to the attached drawings, in which:

FIG. 1 is a block diagram of a system, including a SIM card, according to an exemplary embodiment of the present invention;

FIG. 2 is a view illustrating pins of a SIM card illustrated in FIG. 1;

FIG. 3 is a view of a data format for wireless data communications between an near field communication (NFC) unit and a card reader system illustrated in FIG. 1, according to an exemplary embodiment of the present invention;

FIG. 4 is a timing graph illustrating a waveform of a start of a file (SOF) illustrated in FIG. 3, according to an exemplary embodiment of the present invention;

FIG. 5 is a view of a data format for wireless communications between a SIM card and an NFC unit illustrated in FIG. 1, according to an exemplary embodiment of the present invention; and

FIG. 6 is a timing graph of a preamble illustrated in FIG. 5, according to an exemplary embodiment of the present invention.

### DETAILED DESCRIPTION OF THE EMBODIMENTS

The present invention will now be described more fully with reference to the accompanying drawings, in which exemplary embodiments of the invention are shown. The invention, however, may be embodied in various different forms, and should not be construed as being limited only to the illustrated embodiments. Rather, these embodiments are provided as examples, to convey the concept of the invention to one skilled in the art. Accordingly, known processes, elements, and techniques are not described with respect to some of the embodiments of the present invention. Throughout the drawings and written description, like reference numerals will be used to refer to like or similar elements.

Embodiments of the present invention provide a subscriber identity module (SIM) card that includes an RF module. The RF module enables, for example, additional interfaces and access to external wireless terminals.

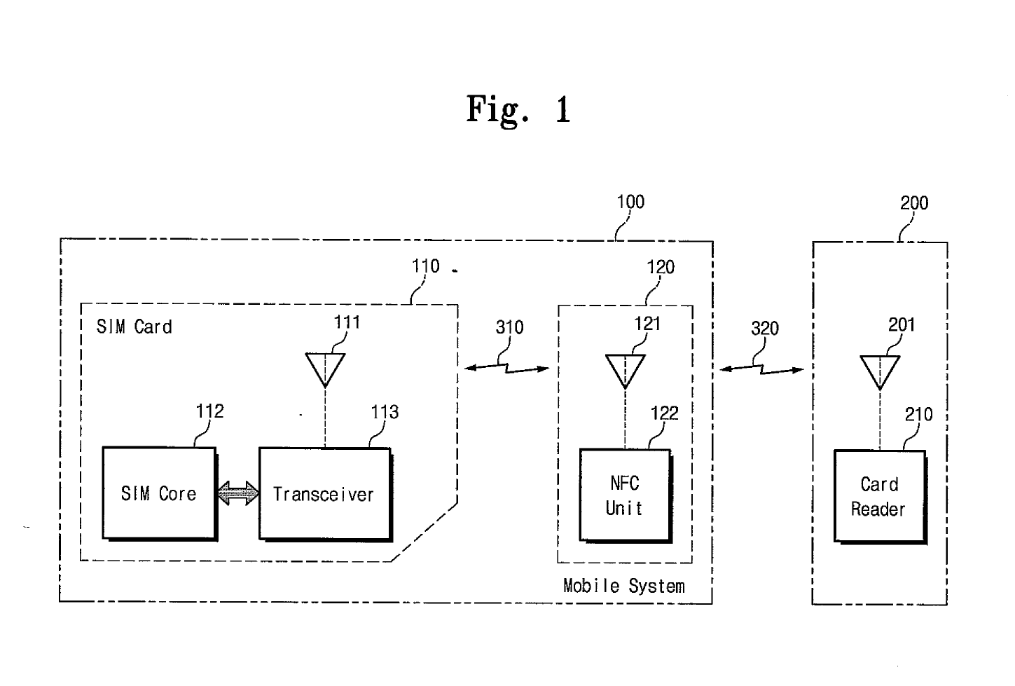

FIG. 1 is a block diagram of a system according to an exemplary embodiment of the present invention. Referring to FIG. 1, a mobile system 100 includes a SIM card 110, in which a transceiver 113, a first antenna 111 and a SIM core 112 are embedded. The mobile system 100 also includes a near field communication (NFC) module 120, which includes an NFC unit 122 and a second antenna 121. A card reader system 200, which may be external to the mobile system 100, includes a card reader 210 and a third antenna 201.

The SIM card 110 includes the SIM core 112, the transceiver 113 and the first antenna 111. The SIM core 112 is a functional circuit core that may be a typical SIM card. For example, the SIM core 112 may include a random access memory (RAM), a read only memory (ROM), a microprocessor and a nonvolatile memory (e.g., a flash memory). The RAM is a memory for data processing of the microprocessor, the ROM is a memory for programming of the microprocessor, and the nonvolatile memory is for storing data. For example, the nonvolatile memory may store data including information about a service provider, as well as data allowing the provided services. The microprocessor performs control operations using instructions and/or data stored in the RAM and programming stored in the ROM, for example, to provide desired services to a user according to information stored in the nonvolatile memory.

The SIM core 112 serves to send and receive data to and from the mobile system 100 using, for example, an ISO 7816 interface. Also, according to an embodiment of the invention, the SIM core 112 can perform wireless data communications with the NFC module 120 through the transceiver 113 and the first antenna 111. The transceiver 113 is a radio frequency (RF) module, which communicates via the first antenna 111.

The mobile system 100 utilizes the NFC module 120 for wireless data communications with the card reader system 200. The NFC module 120 includes an NFC unit 122 and a second antenna 121. The NFC unit 122 can perform wireless data communications with the card reader system 200, or similar external device, through the second antenna 121, and the card reader 210 can perform data communication with the NFC unit 122 through the third antenna 201, using an ISO 14443 interface protocol, for example.

The NFC module 120 (via the NFC unit 122) performs dual-band data transmission/reception of RF data signals with the SIM card 110 and/or the card reader system 200. For example, the NFC module 120 may perform data transmission/reception with the card reader system 200 at 13.56 MHz, using a data format 320, compliant with the ISO 14443 interface protocol. The NFC module 120 may also perform data transmission/reception with the SIM card 110 at 125 KHz, using a data format 310, which may incorporate a modified ISO 14443 interface protocol. Accordingly, the NFC module 120 can access the card reader system 200 and the SIM card 110 simultaneously, using the dual bands of 13.56 MHz and 125 KHz, respectively.

The SIM card 110 has a smaller number of pins and a smaller size than other IC cards. Therefore, although the SIM card 110 includes an antenna 111, the length of the antenna 111 is not sufficient to perform direct wireless communication with an external terminal. For this reason, the NFC unit 122 within the NFC module 120 of the mobile system 100 may be used to enable wireless data communications between the SIM card 110 and an external terminal, such as the card reader 210.

Data related to the mobile system 100 (e.g., personal user information, phone numbers, an address book, text messages, multimedia information, and the like) and stored in the SIM core 112 may be transmitted to the second antenna 121 of the NFC module 120 through the first antenna 111 via the transceiver 113. The data transmitted to the second antenna 121 may be transferred into the mobile system 100 through the NFC unit 122. The mobile system 100 may process the data, and send resultant data to the first antenna 111 of the SIM card 110 through the second antenna 121 of the NFC module 120 via the NFC unit 122. The resultant data transmitted to the first antenna 111 may be sent to the SIM core 112 via the transceiver 113. The SIM card 110 may then update the SIM core 112 with the resultant data.

Alternatively, in the case of an ISO 7816 interface or a high-end product, the SIM card 110 may communicate with other portions of the mobile system 100 through a USB interface or an MMC interface. However, if the memory capacity within the SIM card 110 were to be increased by 1000 times, for example, compared with current memory capacity, sending data to the mobile system 100 through the USB interface or the MMC interface may be limited. Also, when the mobile system 100 uses an internal bus (not shown) to enable the SIM card 110 to communicate with other IC cards within the mobile system 100, an overload may occur.

Thus, to avoid limitations of wired communications and to reduce the load of the mobile system 100, the SIM card 110 according to an embodiment of the present invention may use wireless communications to communicate with other components of the mobile system 100, including RF modules (e.g., the NFC module 120) and/or different types of IC cards attached to the mobile system 100.

Data for various services (e.g., information for financial transactions, electronic money, and the like) stored in the SIM card 110 may be transmitted to the second antenna 121 of the NFC module 120 through the first antenna 111 via the transceiver 113. The NFC unit 122 determines whether the data is to be transmitted within the mobile system 100 or to an external system, such as the external card reader system 200, for example, based on the type of data being transmitted.

When intended for the external card reader system 200, the data received by the NFC unit 122 is transmitted to the third antenna 201 via the second antenna 121. The data received by the third antenna 201 is sent to the card reader 210. The card reader 210 processes the received data, and sends resultant data (if any) to the second antenna 121 through the third antenna 201. The resultant data received by the second antenna 121 is sent to the NFC unit 122 and then transmitted to the first antenna 111 via the second antenna 121. The resultant data received by the first antenna 111 is sent to the SIM core 112 via the transceiver 113. The SIM card 110 may then be updated with the resultant data.

Generally, NFC provides short-range wireless communications, typically involving mobile equipment or personal computers. NFC is a kind of contactless short-range wireless communication that enables data transmissions (e.g., at 424 kbps) within a distance of about 10 cm in a frequency band of 13.56 MHz using low power. Data, such as phone numbers and transaction information used in e-commerce, may be received and transmitted by simply placing at least two NFC terminals in close proximity to one another. There is no additional manipulation or intervention required by the user. NFC technology can be applicable to a next generation, ubiquitous communications environment. NFC technology may be adopted so that data, such as phone numbers, pictures, tickets and MP3 files, can be received/transmitted between devices, such as mobile phones, AV equipment, digital cameras, personal digital assistants (PDAs) and set top boxes, at a high rate without user manipulation.

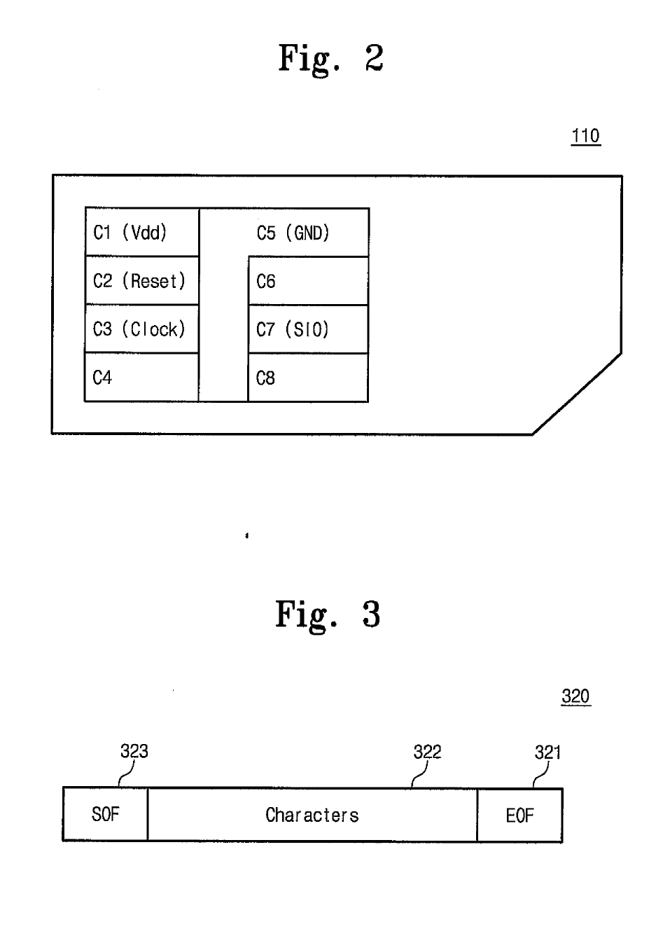

FIG. 2 is a view illustrating pins of the exemplary SIM card 110 depicted in FIG. 1. Referring to FIGS. 1 and 2, the SIM card 110 includes pins C1, C2, C3, C4, C5, C6, C7 and C8. The pins C1, C2, C3, C5 and C7 are used for the ISO 7816 interface protocol. In particular, in accordance with the ISO 7816 interface protocol, the pin C1 is used for power supply Vdd, the pin C2 is used for Reset, the pin C3 is used for Clock, the pin C5 is used for ground GND and the pin C7 is used for serial input/output (SIO). The ISO 7816 interface protocol does not utilize the pins C4, C6 and C8.

As discussed above, in an embodiment of the present invention, the SIM card 110 includes an RF module (e.g., the transceiver 113) to perform wireless communications. Thus, the SIM card 110 can wirelessly communicate with the NFC unit 122 by using the embedded RF module. In turn, the NFC unit 122 may wirelessly communicate with another NFC module, such as the card reader system 200, based on information communicated from the embedded RF module.

FIG. 3 is a view illustrating the data format 320 used for wireless communications between the NFC unit 122 and the card reader 210 of FIG. 1. As discussed above, the NFC module 120 and the card reader system 200 perform wireless communications using the ISO 14443 interface protocol. The data format for the ISO 14443 interface (e.g., data format 320) includes a start of file (SOF) 323, Characters 322 and an end of file (EOF) 321. The SOF 323 indicates a start of the RF data. The Characters 322 includes the data that is to be actually transmitted and received. The EOF 321 indicates an end of the RF data.

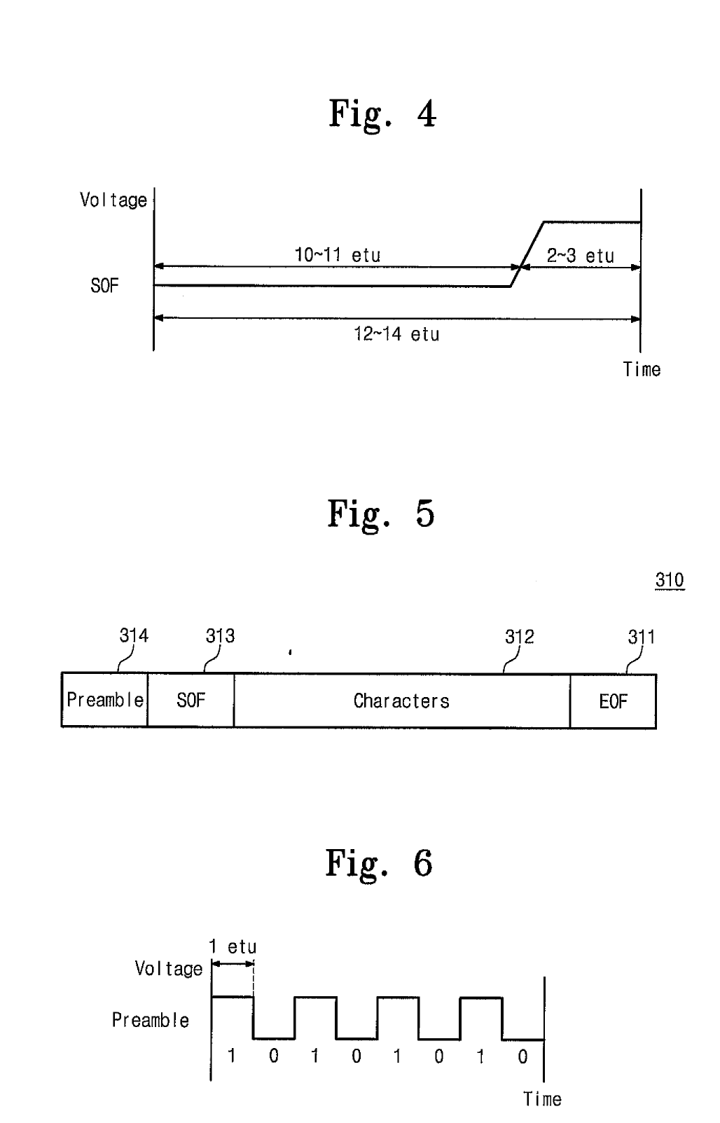

FIG. 4 is a timing graph illustrating a waveform of the SOF 323 of FIG. 3, which indicates a start of the RF data. In accordance with the ISO 14443 interface protocol, the total length of the SOF 323 ranges from 12 to 14 etu. Etu refers to a minimum time of storing 1-bit data. The SOF 323 maintains a low state for 10 to 11 etu at the beginning, and then maintains a high state for 2 to 3 etu. When RF data having the timing of FIG. 4 is transmitted/received, the mobile system 100 or the card reader system 200 recognizes the start of the RF data.

FIG. 5 is a view illustrating the data format 310 used for wireless communications between the SIM core 112 of the SIM card 110 and the NFC unit 122 of the NFC module 120 of FIG. 1. A protocol for wireless data communications between the SIM card 110 and the NFC module 120 is not established. Thus, in an embodiment, an interface between the SIM card 110 and the NEC module 120 adds a preamble to the RF data format of the ISO 14443 interface protocol.

The preamble is a binary stream recorded at the head of the RF data in order to enable synchronization of data and/or to identify the type of data in the transmitted/received data. That is, the preamble indicates that data is about to be transmitted, and defines a series of specific transmission pulses that can be interpreted by communication systems. The preamble is used to enable the systems that are receiving information to identify the start of data transmission.

In an embodiment of the present invention, the preamble is used for identifying the wireless data communications between the SIM card 110 and the NFC module 120. Thus, the NFC module 120 generates a preamble signal 314 (e.g., at the NFC unit 122) in order to identify wireless communications intended for the SIM card 110, and the SIM card 110 generates the preamble signal 314 (e.g., at the transceiver 113 or the SIM core 112) in order to identify wireless communications intended for the NFC unit 122.

Referring to FIG. 5, the preamble 314 is included in the data format 310 between the SIM card 110 and the NFC module 120. As discussed above, the data format 310 thus includes the data format 320 illustrated in FIG. 3 (e.g., the ISO 14443 interface protocol) and the preamble 314. In other words, the remainder of the data format 310 is essentially the same as the data format 320, and includes SOF 313, Characters 312 and EOF 311. As described above with respect to the data format 320, the SOF 313 indicates a start of the RF data, the Characters 312 includes the data to be transmitted or received, and the EOF 311 indicates an end of the RF data.

FIG. 6 is a timing graph corresponding to the preamble 314 of FIG. 5. Referring to FIG. 6, the timing of the preamble 314 is used to identify wireless data communications between the SIM card 110 and the NEC module 120. Like a clock signal, the timing of the preamble 314 includes a pattern of alternating high and low states (e.g., ones and zeros) over a predetermined time. Each of the pulses may have a length of approximately 1 etu. The NFC module 120 can thus distinguish data communications with the SIM card 110, as opposed to the card reader system 200, using the preamble 314.

Despite the limited number of pins of the SIM card, the mobile system, according to embodiments of the present invention, implements wireless data communications by including an RF module within the SIM card. Thus, the SIM card can perform wireless data communications within the mobile system through an NFC module. The SIM card can also perform wireless data communications with external terminals through the NFC module.

While the present invention has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A system comprising:
a subscriber identity module (SIM) card; and
a communication circuit for communicating with an external device through a first wireless interface, and for communicating with the SIM card through a second wireless interface.

2. The system of claim 1, wherein the SIM card comprises:
a functional circuit core;
an antenna; and
a transceiver connected to the functional circuit core and the antenna, the transceiver being configured for at least one of transmitting and receiving a data signal between the functional circuit core and the communication circuit through the antenna, the communication circuit using the second wireless interface.

3. The system of claim 1, wherein the first wireless interface comprises a near field communication interface.

4. The system of claim 1, wherein the first wireless interface and the second wireless interface use different frequency bands for communication.

5. The system of claim 2, wherein the transceiver transmits the data signal to the communication circuit through the second wireless interface, the data signal comprising a preamble added to data output from the functional circuit core.

6. The system of claim 2, wherein the communication circuit transmits the data signal to the transceiver through the second wireless interface, the data signal comprising a preamble added to data to be input to the functional circuit core.

7. A subscriber identity module (SIM) card, comprising:
a SIM core;
an antenna; and
a transceiver, connected to the SIM core and the antenna, for converting data from the SIM core into an RF data signal, and for transmitting the RF data signal through the antenna to a communication circuit, which transmits the RF data signal to an external device.

8. The SIM card of claim 7, wherein the transceiver receives an RF data signal from the external device through the communication circuit and the antenna, and sends at least a portion of the RF data signal to the SIM core.

9. The SIM card of claim 7, wherein the RF data signal comprises a preamble.

10. The SIM card of claim 8, wherein the transceiver adds the preamble of the RF data signal to data provided from the SIM core.

11. The SIM card of claim 7, wherein when the RF data signal received through the antenna comprises a preamble, the transceiver sends at least a portion of the RF data signal to the SIM core.

12. A subscriber identity module (SIM) card, comprising:
a SIM core;
an antenna; and
a transceiver, connected to the SIM core and the antenna, for receiving an RF data signal from an external device through the antenna, via a communications circuit, and for sending at least a portion of the RF data signal to the SIM core.

13. The SIM card of claim 12, wherein the transceiver converts data to be transmitted from the SIM core to the external device into an RF data signal and transmits the RF data signal through the antenna to the communications circuit, which transmits the RF data signal to an external device.

14. The SIM card of claim 12, wherein the RF data signal comprises a preamble.

15. The SIM card of claim 13, wherein the RF data signal transmitted to the communications circuit through the antenna comprises a preamble added to the data provided from the SIM core.

16. The SIM card of claim 12, wherein when the RF data signal received through the antenna includes a preamble, the transceiver sends at least a portion of the RF data signal to the SIM core.
